(19) United States
(12) Patent Application Publication
(10) Pub. No.: US 2004/0098257 A1
(43) Pub. Date: May 20, 2004

(54) Method and apparatus for removing noise from audio frame data

(75) Inventor: Koichi Katsuya, Tokyo-to (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/662,387

(22) Filed: Sep. 16, 2003

(30) Foreign Application Priority Data
Sep. 17, 2002 (JP) P2002-270324

(51) Int. Cl. G10L 21/02

(52) U.S. Cl. 704/226

(57) ABSTRACT

A noise removal apparatus is provided for removing noise from frames of digital audio data. The apparatus comprises an error detector and a decoder. The error detector detects whether or not there occurs an error in a coded audio data composed of the digital audio data. The decoder decodes the coded audio data, in which a window function is applied to the coded audio data, and results coming from the application of the window function to different coded audio data are mutually added. The coded audio data to be decoded is error-free coded audio data inputted immediately before the occurrence of the error when the error detector detects that there occurs the error in the coded data.

### BACKGROUND OF THE INVENTION

The present invention relates to a method and apparatus for removing noise from frames of digital audio data, and in particular to the method and apparatus for removing noise from frames of compressed digital audio data.

A conventional reproduction method of compressed audio data requires detection of an error in each frame of compressed audio streams. In general, this detection has been conducted with the use of a technique called CRC (Cyclic Redundancy Check). If audio data is compressed with a technique known as AAC (Advanced Audio Coding) that is one of the compressed audio-data reproduction methods, a range in which an error is detected by using the CRC is not the entire stream of compressed audio data, but part thereof. The compressed audio-data stream is an aggregation of frames of audio data, while ISDB-TSB (Integrated Services Digital Broadcasting-Terrestrial Sound Broadcasting) uses ADTS (Audio Data Transport Stream) frames based on the AAC.

FIG. 1 illustrates the structure of an ADTS frame. The ADTS frame is made up of three parts of ADTS header, CRC, and Raw_Data_Block. In the ADTS header is written a variety of types of information. In the CRC is written a result showing the error check carried out partly in the ADTS frame. In the Raw_Data_Block is written pieces of information indicative of both compressed audio data and the type thereof.

FIG. 2 illustrates the structure of each Raw_Data_Block, which is composed of IDs each indicating the type of compressed audio data, Syntactic Elements that are compressed audio data, and a byte alignment showing other data. The types and number of IDs depend on the configurations and profiles of the ISDB-TSB. FIG. 3 shows the types of IDs.

In FIG. 3, from the left, the names of eight types of Syntactic Elements, ID names, ID codes, and abbreviations of the Syntactic Elements are listed in sequence. The third ID_CCE is not used by the ISDB-TSB.

FIG. 4 is a flowchart showing how to detect an error carried out by a conventional AAC decoder. As shown therein, at step S1, one frame of data of an audio compressed stream is inputted to a buffer in the decoder. At step S2, a header is acquired from the one frame of data that has been received. In the header, there are stored pieces of information showing an ID, layer, protection bits, profile, and sampling frequency. Then at step S3, it is determined if the information shown by the header is consistent with the specifications according to the AAC. In cases where such a consistency is detected (Yes at step S3), the processing is made to proceed to step S4, while in cases where such a consistency cannot be detected (No at step S3), the processing is skipped to step S8.

At step S4, acquired from the ADTS frame is the Raw_Date_Block, in which, as described in FIG. 2, various types of IDs and Syntactic Elements are stored. At step S5, it is then determined if or not the Raw_Date_Block includes only IDs which fall into those shown in FIG. 3. In the case that only the IDs which fall into those shown in FIG. 3 are included (Yes at step S5), the processing is made to go to step S6, while when IDs different from the IDs shown in FIG. 3 are included (No at step S5), the processing is made to proceed to step S8. Specifically, if the code indicating the type of each ID agrees with any of 0X0 to 0X7, the process at step S6 is carried out, while such an agreement cannot be realized, the process at step S8 is carried out.

At step S6, a check based on the CRC is executed. In the ADTS frame based on the AAC, targets to be subjected to the CRC are the entire ADTS header, the first 192 bits of each in the SCE, CPE, CCE, LFE of the IDs shown in FIG. 2, the first 128 bits of a channel_pair_element which is the second element in the CPE, and all the data in both of the PCE and DSE. These data to be targeted for the CRC is applied to a formation polynomial, and then a result of this calculation is compared with a value based on the CRC created immediately at the ADTS header. If there is an agreement between both the values, it is determined that there is no error in the fame data, before the processing is made to go to step S7. In contrast, however, when it is determined that such an agreement cannot be attained, it is determined that there is an error in the frame data. In this case, the processing is handed over to step S8.

As understood from the above, each ID, a fill_element, bits after the first 192 bits in each of the SCE, CPE, CCE and LFE, and data after the first 128 bits of the channel_pair_element which is the second element in the CPE are not subjected to the error check.

At step S7, the ADTS frame in which there is no error is decoded.

On the other hand, at step S8, the processing for the case where there is an error in the frame data is carried out. In this case, the ADTS frame is not subjected to decoding, but all data showing the decoded results are replaced by “zero.”

That is, the data of the frame in which there is an error is outputted as being “zero” and subjected to soft muting (fading in/fading out), so that non-listenability resulting from an error in the ADTS frame can be suppressed. This technique provides a conventional first prior art. In addition, a conventional second technique for suppressing non-listenability is to repeat the previous data for output.

In connection with FIGS. 5 and 6, these conventional techniques can be explained more. FIG. 5 conceptually illustrates the first conventional first technique, and FIG. 6 conceptually illustrates the second conventional second technique.

In FIG. 5, the upper stage depicts input data, the intermediate stage depicts a decoder for the input data, and the lower stage depicts output data decoded by the decoder, respectively. In the example shown in FIG. 5, three ADTS frames 0 to 2 are illustrated as the input data, in which data showing the CRC is attached to each ADTS frame. If the CRC in the frame shows that there is an error in the frame 1, all data of a frame 1A that corresponds to a decoded result of the frame 1 are forcibly set to “zero.” As a result, since there occurs an interruption of data between the frames 0A and 2A, the output begins to lower little by little at a position starting from given data of the frame 0A, which is near to the frame 1A, and then the output begins to rise little by little at a position starting from given data of the frame 2A, which is near to the frame 1A. Thus the output fades out, and then fades in, with the result that the listenability at an error-causing frame is prevented from being spoiled.

In FIG. 6, the upper stage depicts input data, the intermediate stage depicts a decoder for the input data, and the lower stage depicts output data decoded by the decoder, respectively. In the example shown in FIG. 6, three ADTS frames 3 to 6 are illustrated as the input data, in which data showing the CRC is attached to each ADTS frame. If the CRC in the frame 4 shows that there is an error in the frame 4, all data of a frame 4A that corresponds to a decoded result of the frame 4 are forcibly replaced by the data of the frame 3A with no error, which is a frame immediately before the frame 4A. This way also prevents the listenability at an error-causing frame from being spoiled.

However, the foregoing conventional countermeasures have still suffered from various difficulties. One difficulty is that the CRC is low in error detection capability, because the CRC allows only part of each frame to be subjected to error detection. In addition, the error processing based on the soft muting technique (fading in/fading out) shown in FIG. 5 is not always sufficient in obtaining a high listenability and is sometimes not easy to listen, since output sound changes from a sound state (normal frame), to a sound-less state (error-causing frame), and to a sound state. Further, in the case of the technique of replacing the data of an error-causing frame by the data of a frame immediately before the error-causing frame, there occurs a feeling that the sound heard is drawling or the sound skips when an error is detected.

### SUMMARY OF THE INVENTION

The present invention has been made in view of the above circumstances, and an object of the present invention is therefore to raise the capability of detecting an error in an ADTS frame more than that based on the CRC so that sound outputted at the timing when an error is detected becomes easier to listen.

In order to realize the above object, as one aspect, the present invention provides a noise removal apparatus for removing noise from frames of digital audio data, the apparatus comprising: an error detector configured to detect whether or not there occurs an error in a coded audio data composed of the digital audio data; and a decoder configured to decode the coded audio data, the decoding including application of a window function to the coded audio data and mutual addition of results coming from the application of the window function to different coded audio data, the coded audio data to be decoded being error-free coded audio data inputted immediately before the occurrence of the error when the error detector detects that there occurs the error in the coded data.

In order to realize the above object, as another aspect, the present invention provides a noise removal method for removing noise from frames of digital audio data, the method comprising the steps of: detecting whether or not there occurs an error in a coded audio data composed of the digital audio data; and decoding the coded audio data, the decoding including application of a window function to the coded audio data and mutual addition of results coming from the application of the window function to different coded audio data, the coded audio data to be decoded being error-free coded audio data inputted immediately before the occurrence of the error when the error detector detects that there occurs the error in the coded data.

In order to realize the above object, as further aspect, the present invention provides a program enabling a computer to function for removing noise from frames of digital audio data, the computer providing the functions of: detecting whether or not there occurs an error in a coded audio data composed of the digital audio data; and decoding the coded audio data, the decoding including application of a window function to the coded audio data and mutual addition of results coming from the application of the window function to different coded audio data, the coded audio data to be decoded being error-free coded audio data inputted immediately before the occurrence of the error when the error detector detects that there occurs the error in the coded data.

### BRIEF DESCRIPTION OF THE DRAWINGS

Other objects and aspects of the present invention will become apparent from the following description and embodiments with reference to the accompanying drawings in which:

FIG. 1 shows the structure of an ADTS frame;

FIG. 2 shows the structure of a Raw_Data_Block included in the ADTS frame;

FIG. 3 is a table explaining ID types including in the Raw_Data_Block ;

FIG. 4 is a flowchart showing a conventional technique for detecting an error, which is carried out by a conventional decoder;

FIG. 5 illustrates the concept of a conventional first technique for error processing;

FIG. 6 illustrates the concept of a conventional second technique for error processing;

FIG. 7 is a flowchart explaining how to detect an error, which is carried out in a first embodiment according to the present invention;

FIG. 8 is an explanation of encoding and decoding procedures in the first embodiment;

FIG. 9 is a flowchart explaining how to detect an error, which is carried out in a second embodiment according to the present invention; and

FIG. 10 is a block diagram of an apparatus according to a third embodiment of the present invention, the apparatus being directed to error detection and decoding.

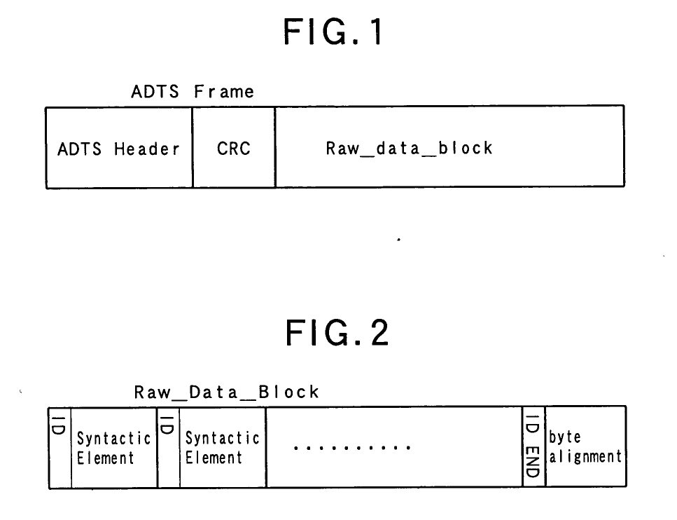

### DETAILED DESCRIPTION OF THE PREFERRED EMBODIMENTS

Preferred embodiments of a noise removal apparatus according to the present invention will now be described in connection with the accompanying drawings.

(First Embodiment)

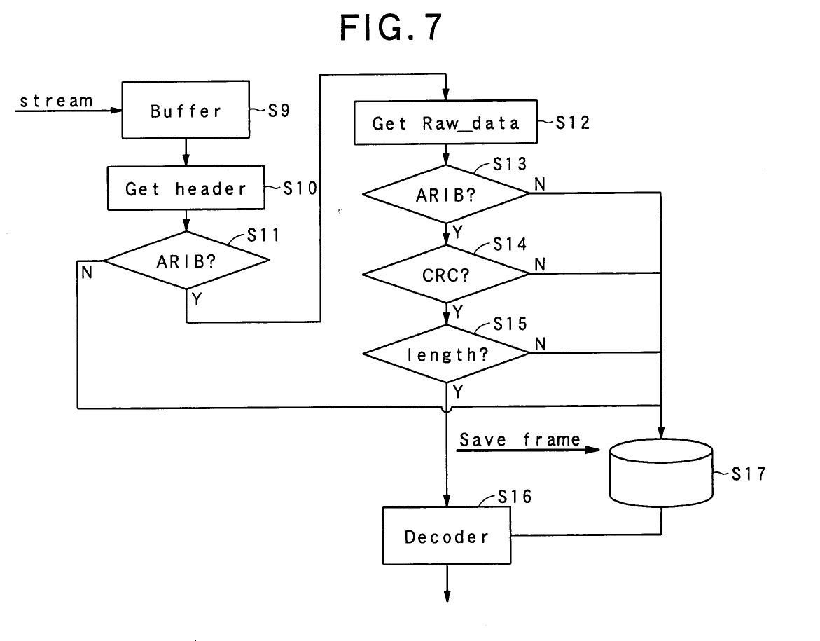

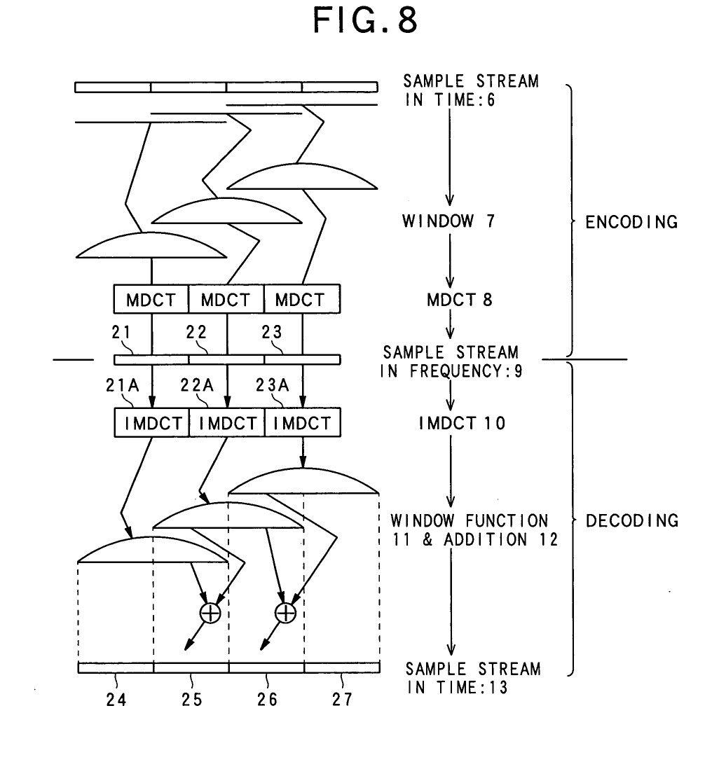

Referring to FIGS. 7 and 8, a first embodiment of the noise removal apparatus according to the present invention will now be described.

FIG. 7 is a flowchart showing the processing carried out by the noise removal apparatus on the basis of an error detection technique according to the present invention.

The present embodiment will be explained about an application in which the error detection apparatus according to the present invention is applied to processing of an ADTS (Audio Date Transport Stream) frame coded on AAC (Advanced Audio Coding) adopted by ISDB-TSB (Integrated Services Digital Broadcasting-Terrestrial Sound Broadcasting).

At step S9, one frame (ADTS frame) of the data stream is inputted to a buffer of the apparatus. At step S10, a header is acquired form the one frame inputted at step S9. Various types of information, such as ID, layer, protection bit, bit rate, and sampling frequency, are stored in the header. At step S11, it is determined whether or not the information about the header meets corresponding specifications stipulated by ARIB (Association of Radio Industries and Businesses), which provides the specifications for the ISDB-TSB. If it is determined that the header information meets the corresponding specifications provided by the ARIB, the processing is made to go to step S12. In contrast, if the determination is that the header information does not meet the corresponding specifications, the processing is made to skip to step S17.

For example, the sampling frequency can be described as follows. The AAC technical standards define 12 types of sampling frequencies. The ARIB for the ISDB-TSB adopts only three types of sampling frequencies, i.e., 48 kHz, 32 kHz and 24 kHz, from the 12 types of sampling frequencies. Thus, when the sampling frequency stored in the header meets any of 48 kHz, 32 kHz and 24 kHz, the processing moves from step S11 to S12. On the other hand, such a determination cannot be obtained, the processing skips to step S17.

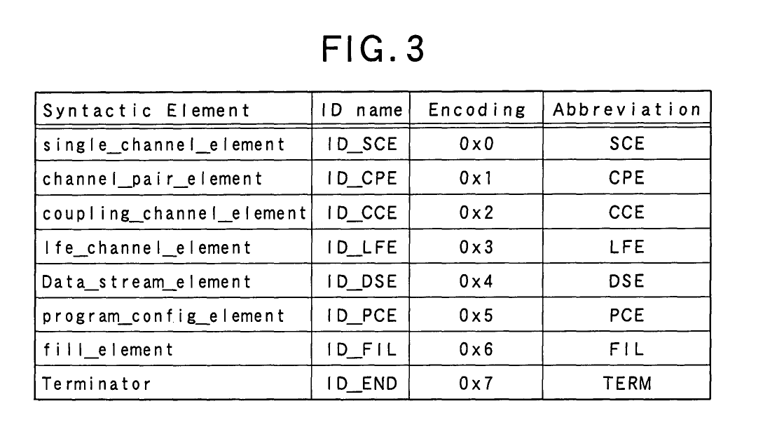

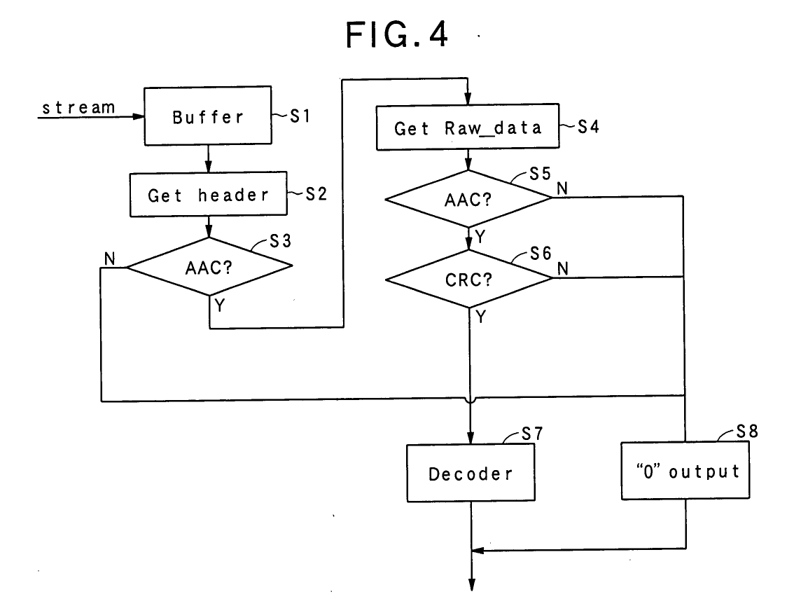

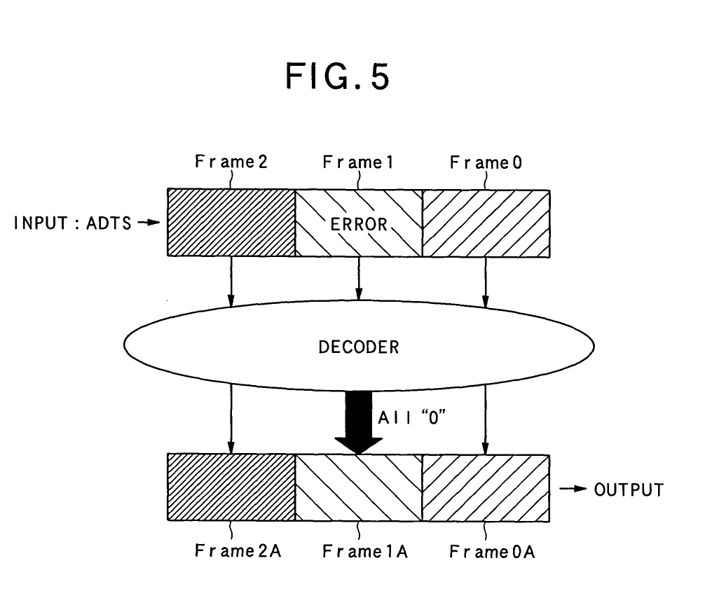

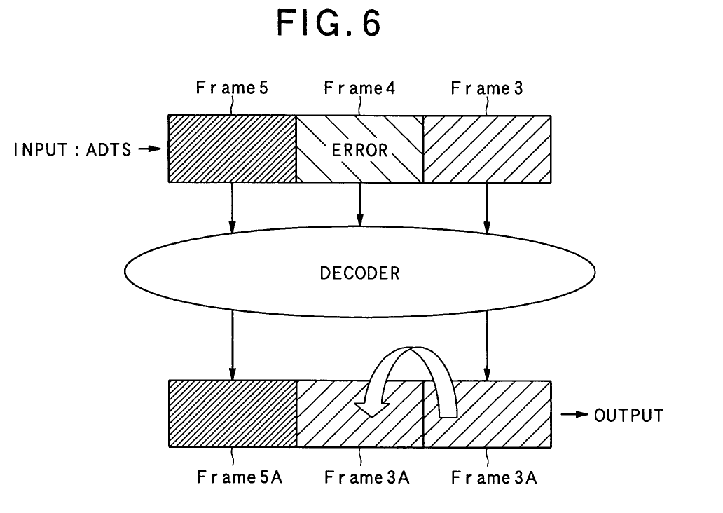

At step S12, a Raw_Data_Block is acquired from the ADTS frame. As shown in FIG. 3, various types of IDs and Syntactic Elements are stored in the Raw_Data_Block . Then, at step S13, it is determined whether or not, of the various types of IDs, an ID name that is incompatible with the ISDB-TSB is in the Raw_Data_Block . When any ID in the Raw_Data_Block is not compatible with those usable in the ISDB-TSB, the processing is made to go to step S17, while when the IDs in the Raw_Data_Block are compatible with those usable in the ISDB-TSB, the processing is made to go to step S14.

At step S14, the ADTS frame undergoes CRC (Cyclic Redundancy Check) to see if there is an error therein, like the conventional manner. When an error has been found by the CRC, the processing will be carried out at step S17. In contrast, when no error has been found by the CRC, the processing is made to proceed to step S15.

At step S15, based on information indicative of a frame length included in the header of the ADTS frame, it is further determined if the entire length of the frame that has been processed by the CRC is consistent with the frame length information. To be specific, the number of bits that has been subjected to the CRC is counted from the top of the header to the last bit of the byte alignment shown in FIG. 2. It is then determined if or not the number of bits that has been counted is consistent with the frame length information written in the header of the ADTS frame. When there is no consistency, it is considered that there occurs an error in the frame, whereby the processing is then carried out at step S17. In contrast, when there is a consistency, it is considered that there is no error in the frame, so that the processing is made to go to step S16. In the case that the processing is shifted to step S16, the contents of the frame that has been acquired are also written in a memory for decoding.

At step S16, the ADTS frame which has been acquired is subjected to decoding. The decoding operations will now be described with reference to FIG. 8. In FIG. 8, the upper half-section shows encoding operations, while the lower half-section shows the decoding operations which will now be described. Frames 21, 22 and 23 in a frequency sample stream 9 are frames to be acquired. In the decoding, each frame is first subjected to IMDCT (Inverse Modified Discrete Cosine Transform) 10. This IMDCT 10 is based on the following transform formula:

Xi,n=2/NΣ(from 0 to N/2−1) spec [i][k] cos (2π/N(n+n0) (k+1/2),

wherein 0≦n<N, (n: sample index, i: windows index, k: spectral coefficient index, N: window length based on the window sequence value, and n0=(N/2+1)/2).0

Then, a window function 11 is applied to each of output blocks 21A, 22A and 23A resulting from the IMDCT 10. The window function 11 can be considered one kind of filter. Each frame has a frequency characteristic, which depends on a window function to be applied to the frame. Using the window function 11 allows each block to have continuity from and to both adjacent blocks. The AAC defines two types of window functions, which are a sine widow and a Kaizer-Bessel window that is superior in selectivity from an adjacent band, and any of the two types of window functions can be applied to the window function 11.

The window function 11 is applied to each extended block region in the IMDCT 10, in which each extended block region is formed by adding half a size of each of both adjacent blocks to a central block to be targeted. In the example shown in FIG. 8, both blocks 21A and 23A are adjacent to the block 22A, so one extended block region is formed by adding half a size of each of both blocks 2 1A and 23A to the central block 22A. The designated window function 11 is applied to each extended block region.

Then, overlapped regions between two adjacent extended block regions (i.e., half a region of each extended block region), which have been processed with the window function 11, are subjected to mutual addition 12. This produces a time sample stream 13, so that an audio signal can be reproduced.

Accordingly, if there is an error in the frame 22 (, so that a decoded result would be zero if the conventional technique is applied), the frame 22 is avoided from being outputted as being sound-less. The reason is that blocks 25 and 26 in the time sample stream 13, each of the blocks 25 and 26 is in part resulted from the decoded frame 22, includes data in the second half of the block 21A and data in the first half of the block 23A, receptively, thus avoiding the sound-less output. In addition, the decoded results before and after the two blocks (e.g., the blocks 21 and 23) are included in the data in the temporal blocks 25 and 26, whereby the data in the temporal blocks 25 and 26 is able to sustain continuity correlated to a larger extent with the data in the frequency block 22.

Every time the processing is carried out at step S17, a frame that has been determined to be no error, which is detected by means of the error checks conducted in the period from the steps S9 to S15, is memorized. Accordingly, if there occurs an error in any frame, the frame subjected to the decoding processing at step S16 becomes a frame with no error, which is stored at step S17 and positioned immediacy before the error-causing frame. In contrast, even if there is detected an error in a frame, as described in the decoding at step S16, continuity in adjacent frame data is still secured, because the processing based on the window function 11 involves data in successive frames before and after each frame. Hence, a sudden intermittence in the output sound to be reproduced can be avoided.

The AAC uses a block coding manner. Hence, when coded frames are decoded into a temporal signal by the decoder, compression-specific distortion is spread within each block. When making it different how to compress each block, converting a frequency sample stream to a time sample stream will generate discontinuity between blocks, thus providing distortion called block distortion. In the field of the audio, sound resulting from this discontinuous block distortion is, in most cases, unpleasant to a listener. Therefore, at step S17, applying the window function 11 to each extended block region makes it possible to secure continuity between data in the consecutive two blocks, thus leading to a smooth connection of the blocks. The block distortion is therefore lessened in the sound that has been reproduced.

(Second Embodiment)

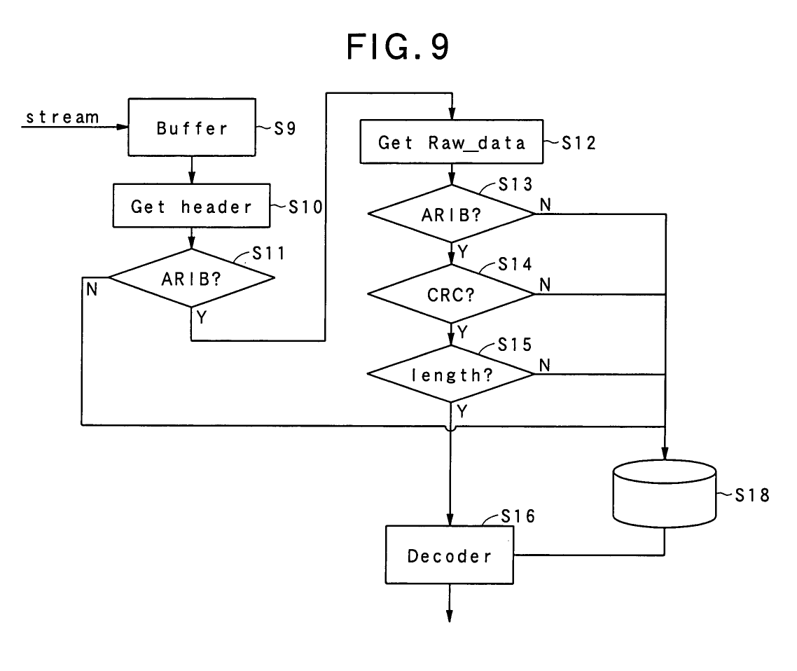

Referring to FIG. 9, a second embodiment of the noise removal apparatus according to the present invention will now be described.

FIG. 9 is a flowchart explaining how to detect an error in the ADTS frame, which is carried out in the second embodiment, in which the same references as those in FIG. 7 are given to the identical or similar processes to those in FIG. 7, for the sake of a simplified explanation.

The processing shown in FIG. 9 differs from that in the first embodiment in the processing carried out at step S18.

Frame data memorized at step S18 is such frame data when decoded at step S16, the result of the decode becomes zero.

To be specific, in cases where an error in a frame is detected at each of steps S11, S13, S14 and S15 in FIG. 9, a decoded result of the frame becomes zero. In this case, at step S16, a window function is applied, in the IMDCT10, to each extended block region consisting of each specific output block and half of each of the output blocks adjacent to the specific output block. That is, as shown in FIG. 8, a window function is applied respectively to each extended block region formed of the block 22A and half of each of the blocks 21A and 23A adjacent to the block 22A. In other words, each extended block region includes, from a viewpoint of size, half a block overlapped from each of both adjacent blocks.

After this window processing, overlapped regions between two adjacent extended block regions (i.e., half a region of each extended block region), which has been processed with the window function, are subjected to mutual addition. Thus an audio signal can be reproduced.

As a result, even if a decoded result itself of a certain frame is zero, decoded results of two frames before and after the certain frame are outputted as the decoded result (i.e., output signal) of the certain frame. Thus, the decoded signal can be taken out as a sound signal, though its amount is lowered, which is continuous in its sound state and is related to each other among successive frames, without changing from the sound state (normal frame), to the sound-less state (error-causing frame), and to the sound state (normal frame), like the conventional.

As described above, since the processing at step S18 is configured to memorize frame data of which decoded result becomes zero, the output blocks can smoothly be connected to each other with the data outputted from the blocks connected continuously. Thus, the block distortion can be relieved, reducing an unpleasant feeling to a listener.

(Third Embodiment)

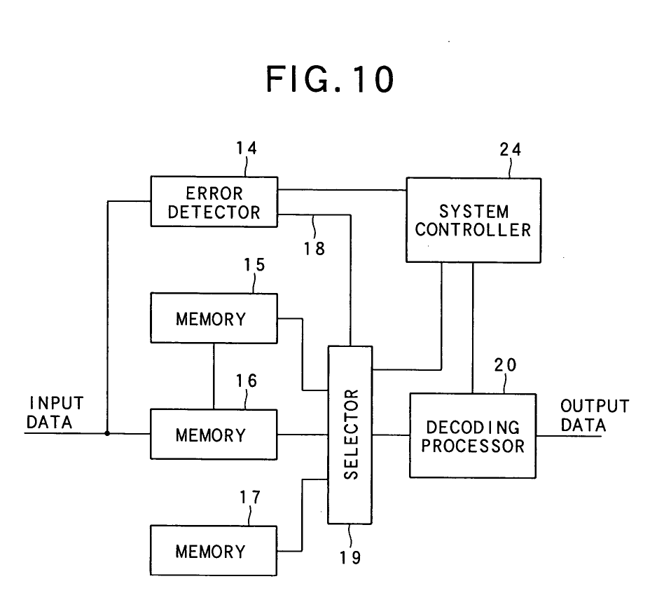

Referring to FIG. 10, a third embodiment of the noise removal apparatus according to the present invention will now be described.

FIG. 10 is a block diagram showing the error detection and decoding operation carried out in the third embodiment.

The noise removal apparatus according to FIG. 10 is provided with an error detector 14, memories 15 to 17, selector 19, decoding processor 20, and system controller 24.

Frame data is inputted, as input data, frame by frame, to both the error detector 14 and the memory 16. The error detector 14 performs the processing shown at steps S11, S13, S14 and S15 in FIG. 9 in sequence. If it is determined by the error detector 14 that there is an error in the data of a frame, an input switchover signal 18 enables the selector 19 to selectively output data stored in either the memory 15 and the memory 17 to the decoding processor 20. In the memory 15, the data of a frame (with no error) acquired immediately before the occurrence of the error. Meanwhile, in the memory 17, patterns of frames providing a decoded result of zero are memorized.

When the error detector 14 determines that there is no error in a frame, the input switchover signal 18 allows the selector 19 to provide the data stored in the memory 16 to the decoding processor 20. Because the memory 16 memorizes the data of a current frame which is in the current error detection, the current frame is subjected to decoding, as the normal procedures, if it is determined that there is no error in the frame.

Namely, the input switchover signal 18 makes it possible to selectively provide the decoding processor 20 with the data in any of the memories 15 to 17.

The decoding processor 30 applies decoding to the acquired frame. This decoding will now be described in connection with FIG. 8. The lower part in FIG. 8 illustrates the decoding processing. The frequency sample stream corresponds to frames acquired by the memory 16. The IMDCT processing is applied to a frame to be decoded.

A window function is then applied to the frame resulting from the IMDCT. This window function can be considered one kind of filter. Each frame has a frequency characteristic, which depends on a window function to be applied to the frame. The AAC defines two types of window functions, which are a sine widow and a Kaizer-Bessel window that is superior in selectivity from an adjacent band, and any of the two types of window functions can be applied to the window function.

The window function is applied to each extended block region in the IMDCT, in which each extended block region is formed by adding half a size of each of both adjacent blocks to a central block to be targeted. In the example shown in FIG. 8, both blocks 21A and 23A are adjacent to the block 22A, so one extended block region is formed by adding half a size of each of both blocks 21A and 23A to the central block 22A. The designated window function is applied to each extended block region.

Overlapped regions between two adjacent extended block regions, which have been processed with the window function, are then subjected to mutual addition. This produces a time sample stream, so that an audio signal can be reproduced.

Accordingly, when an error is detected in a frame, either the data stored in the memory 15 (that is, the data in a frame immediately before the error occurs) or the data stored in the memory 17 (that is, the data in a frame providing a decoded result of “0”) is subjected to decoding. However, in either of the cases, the error-causing frame will not lead to a sound-less state, because the frames before and after the error-causing frame provide output sound, instead of a decoded result of the error-causing frame. Continuity of the data through the error-causing frame can be secured, whereby the sound outputted when an error is detected can be improved in terms of its listenability.

Incidentally, how to remove noise according to the present invention is clearly described in FIGS. 7 and 8, in which the processing shown therein is carried out by the noise removal apparatus.

In addition, programs represented by the flowcharts shown in FIGS. 7 and 9 can be recorded into a recording medium, such as flexible disk or hard disk, or can be delivered to a computer via a communication network such as the Internet. A computer, such as microcomputer, reads out the program recorded in the recording medium or delivered via the communication network, to execute the read program. This configuration enables the microcomputer or others to operate as a system controller.

The foregoing embodiments according to the present invention are also applicable to MP3 (MPEG-1 Audio Layer-III), AC-3 (Audio Code No.3), MPEG-4 (Motion Picture Experts Group 4), ATRAC (Adaptive Transform Acoustic Coding) and others, as long as the MDCT is used in those audio compression algorithms.

For the sake of completeness, it should be mentioned that the embodiment explained so far is not a definitive list of possible embodiments of the present invention. The expert will appreciate that it is possible to combine the various construction details or to supplement or modify them by measures known from the prior art without departing from the basic inventive principle.

The entire disclosure of Japanese Patent Application No. 2002-270324 filed on Sept. 17, 2002 including the specification, claims, drawings and summary is incorporated herein by reference in its entirety.

What is claimed is:

1. A noise removal apparatus for removing noise from frames of digital audio data, the apparatus comprising:
an error detector configured to detect whether or not there occurs an error in a coded audio data composed of the digital audio data; and
a decoder configured to decode the coded audio data, the decoding including application of a window function to the coded audio data and mutual addition of results coming from the application of the window function to different coded audio data, the coded audio data to be decoded being error-free coded audio data inputted immediately before the occurrence of the error when the error detector detects that there occurs the error in the coded data.

2. The noise removal apparatus according to claim 1, wherein the error detector is configured to determine whether or not a descriptor included in the coded audio data is consistent with a descriptor to be used for a descriptor for specifications of a specific broadcasting service.

3. The noise removal apparatus according to claim 1, wherein the error detector is configured to determine whether or not there occurs an error in the coded audio data with the use of a data length descriptor included in the coded audio data.

4. The noise removal apparatus according to claim 1, wherein the decoder is configured to decode the coded audio data providing a decoded result of zero when the error detector detects that there occurs the error in the coded data.

5. A noise removal method for removing noise from frames of digital audio data, the method comprising the steps of:
detecting whether or not there occurs an error in a coded audio data composed of the digital audio data; and
decoding the coded audio data, the decoding including application of a window function to the coded audio data and mutual addition of results coming from the application of the window function to different coded audio data, the coded audio data to be decoded being error-free coded audio data inputted immediately before the occurrence of the error when the error detector detects that there occurs the error in the coded data.

6. The noise removal method according to claim 5, wherein the detecting step determines whether or not a descriptor included in the coded audio data is consistent with a descriptor to be used for a descriptor for specifications of a specific broadcasting service.

7. The noise removal method according to claim 5, wherein the detecting step determines whether or not there occurs an error in the coded audio data with the use of a data length descriptor included in the coded audio data.

8. The noise removal method according to claim 5, wherein the decoding step decodes the coded audio data providing a decoded result of zero when it is detected that there occurs the error in the coded data.

9. A program enabling a computer to function for removing noise from frames of digital audio data, the computer providing the functions of:
detecting whether or not there occurs an error in a coded audio data composed of the digital audio data; and
decoding the coded audio data, the decoding including application of a window function to the coded audio data and mutual addition of results coming from the application of the window function to different coded audio data, the coded audio data to be decoded being error-free coded audio data inputted immediately before the occurrence of the error when the error detector detects that there occurs the error in the coded data.

10. The program according to claim 9, wherein the detecting function determines whether or not a descriptor included in the coded audio data is consistent with a descriptor to be used for a descriptor for specifications of a specific broadcasting service.

11. The program according to claim 9, wherein the detecting function determines whether or not there occurs an error in the coded audio data with the use of a data length descriptor included in the coded audio data.

12. The program according to claim 9, wherein the decoding function decodes the coded audio data providing a decoded result of zero when it is detected that there occurs the error in the coded data.
